(19) United States
(12) Patent Application Publication
(10) Pub. No.: US 2019/0189315 A1
(43) Pub. Date: Jun. 20, 2019

(54) MAGNETIC MATERIAL, PERMANENT MAGNET, ROTARY ELECTRICAL MACHINE, AND VEHICLE

(71) Applicant: KABUSHIKI KAISHA TOSHIBA, Tokyo (JP)

(72) Inventors: Masaya Hagiwara, Yokohama Kanagawa (JP); Shinya Sakurada, Shinagawa Tokyo (JP); Naoyuki Sanada, Yokohama Kanagawa (JP); Keiko Okamoto, Kawasaki Kanagawa (JP)

(21) Appl. No.: 16/283,936

(22) Filed: Feb. 25, 2019

Related U.S. Application Data
(63) Continuation of application No. PCT/JP2018/032928, filed on Sep. 5, 2018.

(30) Foreign Application Priority Data
Sep. 20, 2017 (JP) 2017-180390
Mar. 2, 2018 (JP) PCT/JP2018/007930

(51) Int. Cl. H01F 1/055; H02K 7/00; H02K 7/18; C22C 38/16; C22C 38/14; C22C 38/12; C22C 38/10; C22C 38/00

(52) U.S. Cl. CPC H01F 1/055; H02K 7/003; H02K 7/1823; C22C 38/16; C22C 38/14; C22C 2202/02; C22C 38/10; C22C 38/008; C22C 38/005; C22C 38/002; C22C 38/001; C22C 38/12

(57) ABSTRACT

A magnetic material is expressed by a composition formula 1: (R₁₋ₓYₓ)ₐM_{b}T_{c}D_{d}. The magnetic material includes: a main phase having a ThMn₁₂ crystal phase, and a sub phase having a phase containing the element D.

### CROSS-REFERENCE TO RELATED APPLICATIONS

This application is a continuation of prior International Application No. PCT/JP2018/032928 filed on Sep. 5, 2018, which is based upon and claims the benefit of priority from Japanese Patent Application No. 2017-180390 filed on Sep. 20, 2017 and International Application No. PCT/JP2018/007930 filed on Mar. 2, 2018; the entire contents of all of which are incorporated herein by reference.

### FIELD

Embodiments described herein generally relate to a magnetic material, a permanent magnet, a rotary electrical machine, and a vehicle.

### BACKGROUND

Permanent magnets are used for products in a wide field including, for example, rotary electrical machines such as a motor and a generator, electrical apparatuses such as a speaker and a measuring device, and vehicles such as an automobile and a railroad vehicle. In recent years, reduction in size of the above-described products has been demanded, and high-performance permanent magnets with high magnetization and high coercive force have been desired.

As examples of high-performance permanent magnets, there can be cited rare-earth magnets such as Sm—Co based magnets and Nd—Fe—B based magnets, for example. In these magnets, Fe and Co contribute to increase in saturation magnetization. Further, these magnets contain rare-earth elements such as Nd and Sm, which bring about a large magnetic anisotropy which is derived from a behavior of 4f electrons of the rare-earth elements in a crystal field. Consequently, it is possible to obtain a large coercive force.

### BRIEF DESCRIPTION OF THE DRAWINGS

FIG. 1 is a cross-sectional schematic diagram illustrating a structural example of a metal structure.

FIG. 2 is a cross-sectional schematic diagram illustrating another structural example of a metal structure.

FIG. 3 is a diagram illustrating an example of a permanent magnet motor.

FIG. 4 is a diagram illustrating an example of a variable magnetic flux motor.

FIG. 5 is a diagram illustrating an example of a generator.

FIG. 6 is a schematic diagram illustrating a configuration example of a railway vehicle.

FIG. 7 is a schematic diagram illustrating a configuration example of an automobile.

### DETAILED DESCRIPTION

A magnetic material expressed by a composition formula 1:(R₁₋ₓYₓ)ₐM_{b}T_{c}D_{d}. R is at least one element selected from the group consisting of rare-earth elements, M is Fe or Fe and Co, T is at least one element selected from the group consisting of Ti, V, Nb, Ta, Mo, and W, D is at least one element selected from the group consisting of Cu, and Sn, x is a number satisfying 0.01≤x≤0.8, a is a number satisfying 4≤a≤20 atomic percent, b is a number satisfying b=100−a−c−d atomic percent, and c is a number satisfying 0<c<7 atomic percent, and d is a number satisfying 0.01≤d≤7 atomic percent. The magnetic material comprises: a main phase having a ThMn₁₂ crystal phase and a sub phase having at least one phase selected from the group consisting of a first phase containing 40 atomic percent or more of Cu or a second phase containing 25 atomic percent or more of Sn.

Hereinafter, embodiments will be described while referring to the drawings. Note that the drawings are schematically illustrated, and, for example, a relationship between a thickness and a plane dimension, a ratio of thicknesses of respective layers, and the like, are sometimes different from actual ones. Further, in the embodiments, substantially the same components are denoted by the same reference numerals, and explanation thereof will be omitted.

### First Embodiment

A magnetic material of the present embodiment contains a rare-earth element, an element M (M is Fe or Fe and Co), and an element D (D is at least one element selected from the group consisting of Cu, Sn, In, and Ga). The above-described magnetic material includes a metal structure having main phases and sub phases.

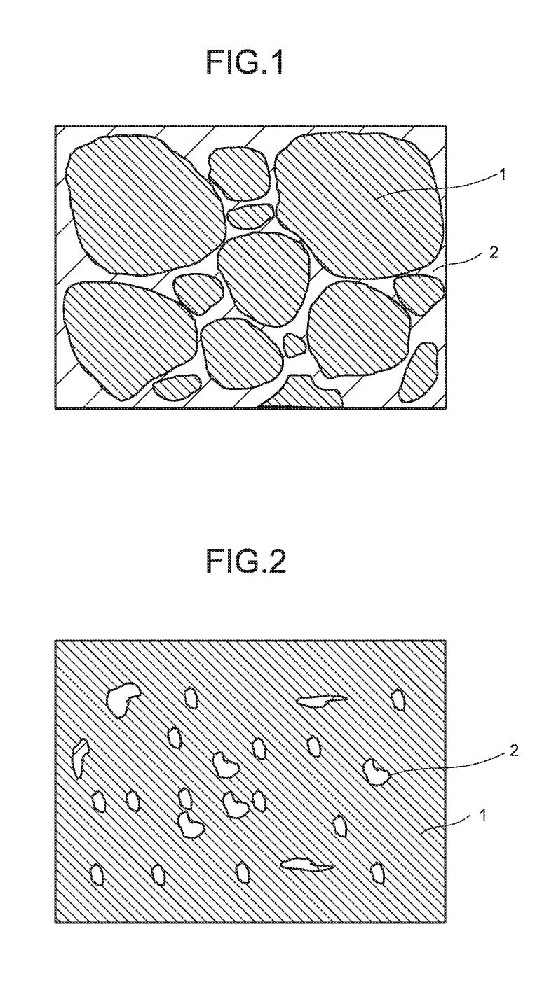

FIG. 1 is a cross-sectional schematic diagram illustrating a structural example of a metal structure. The above-described magnetic material includes a metal structure having crystal phases each containing the high-concentration element M as main phases 1. Saturation magnetization can be improved by increasing a concentration of the element M in the main phase 1, and a coercive force can be improved by forming sub phases 2 each having a phase containing the element D. The main phases 1 are phases having the highest volume occupancy ratio among each crystal phase and amorphous phase in the permanent magnet. The sub phases 2 are disposed on at least one of crystal grains of the main phases 1. Most of the sub phases 2 are disposed between two or more crystal grains of the main phases 1 as a grain boundary phase.

There can be cited, for example, a ThMn₁₂ crystal phase as the crystal phase containing the high-concentration element M. The ThMn₁₂ crystal phase has a crystal structure of tetragonal system. In the magnetic material having the ThMn₁₂ crystal phase as its main phase 1, the high saturation magnetization can be obtained due to the high concentration element M. However, it is difficult to obtain the high coercive force only by the main phase 1. Accordingly, in the magnetic material of the present embodiment, formation of a magnetization-reversal nucleus of the main phase 1 is suppressed, an inverse domain propagation between proximal main phases 1 is suppressed, to thereby improve the coercive force by forming the sub phase 2 including a phase containing the element D while controlling concentration of each element contained in the main phase 1 to stably form the main phase 1 enabling high saturation magnetization.

The magnetic material of this embodiment has a composition expressed by a composition formula 1: (R₁₋ₓYₓ)ₐM_{b}T_{c}D_{d} (in the formula, R is a rare-earth element of one kind or more, T is at least one element selected from the group consisting of Ti, V, Nb, Ta, Mo, and W, M is Fe or Fe and Co, D is at least one element selected from the group consisting of Cu and Sn, x is a number satisfying 0.01≤x≤0.8, a is a number satisfying 4≤a≤20 atomic percent, b is a number satisfying b=100−a−c−d atomic percent, c is a number satisfying 0<c<7 atomic percent, and d is a number satisfying 0.01≤d≤7 atomic percent). The magnetic material may contain inevitable impurities.

Yttrium (Y) is an element effective for stabilization of the ThMn₁₂ crystal phase. Specifically, the element Y can mainly increase stability of the ThMn₁₂ crystal phase through reduction in a crystal lattice caused when it is replaced with the element R in the main phase 1, and the like. When an addition amount of the element Y is too small, it is not possible to sufficiently achieve an effect of increasing the stability of the ThMn₁₂ crystal phase. When the addition amount of Y is too large, an anisotropic magnetic field of the magnetic material significantly lowers. It is preferable that x is a number satisfying 0.01≤0.8, it is more preferable that x is a number satisfying 0.05≤x<0.5, and it is still more preferable that x is a number satisfying 0.1≤0.4.

50 atomic percent or less of the element Y may be replaced with at least one element selected from the group consisting of zirconium (Zr) and hafnium (Hf). The element Zr and the element Hf are elements effective for stabilization of the crystal phase.

The element R is a rare-earth element, and an element capable of providing large magnetic anisotropy to the magnetic material, and giving high coercive force to a permanent magnet. The element R is, concretely, at least one element selected from the group consisting of lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu), and it is preferable to use Sm, in particular. For example, when a plurality of elements including Sm are used as the element R, by setting the Sm concentration to 50 atomic percent or more of all of the elements capable of being applied as the element R, it is possible to increase the performance, for example, the coercive force of the magnetic material.

A concentration a of the element R and the element Y is preferably a number satisfying 4≤a≤20 atomic percent, for example. When the concentration a is less than 4 atomic percent, a large amount of a α-(Fe, Co) phase precipitates, which decreases the coercive force. When the concentration a exceeds 20 atomic percent, a sub phase increases, which decreases the saturation magnetization of the entire magnetic material. The concentration a of the element R and the element Y is more preferably a number satisfying 5≤a≤18 atomic percent, and still more preferably a number satisfying 7≤a≤15 atomic percent.

The element M is Fe or Fe and Co, and is an element responsible for high saturation magnetization of the magnetic material. When compared between Fe and Co, Fe causes higher magnetization, so that Fe is an essential element, and 30 atomic percent or more of the element M is Fe. By making the element M contain Co, the Curie temperature of the magnetic material increases, resulting in that the decrease in the saturation magnetization in a high-temperature region can be suppressed. Further, by adding a small amount of Co, the saturation magnetization can be further increased, when compared to a case where Fe is solely used. On the other hand, if a Co ratio is increased, the decrease in the anisotropic magnetic field is caused. Further, if the Co ratio is too high, the decrease in the saturation magnetization is also caused. For this reason, by appropriately controlling the ratio between Fe and Co, it is possible to simultaneously enable high saturation magnetization, high anisotropic magnetic field, and high Curie temperature. When M in the composition formula 1 is represented as (Fe_{1-y}Co_{y}), a desirable value of y is 0.01≤y<0.7, the value is more preferably 0.01≤y<0.5, and still more preferably 0.01≤y≤0.3. 20 atomic percent or less of the element M may be replaced with at least one element selected from the group consisting of aluminum (Al), silicon (Si), chromium (Cr), manganese (Mn), nickel (Ni), and gallium (Ga). The above-described elements contribute to growth of crystal grains which form the main phase 1, for example.

The element T is at least one element selected from the group consisting of titanium (Ti), vanadium (V), niobium (Nb), tantalum (Ta), molybdenum (Mo), and tungsten (W), for example. By adding the element T, it is possible to stabilize the ThMn₁₂ crystal phase. However, by the introduction of the element T, the concentration of the element M decreases, resulting in that the saturation magnetization of the magnetic material easily decreases. In order to increase the concentration of the element M, it is only required to decrease the addition amount of the element T, but, in such a case, the stability of the ThMn₁₂ crystal phase is lost, and the α-(Fe, Co) phase precipitates, which leads to decrease in the coercive force of the magnetic material. The addition amount c of the element T is preferably a number satisfying 0<c<7 atomic percent. Consequently, it is possible to stabilize the ThMn₁₂ crystal phase while suppressing the precipitation of the α-(Fe, Co) phase. It is more preferable that 50 atomic percent or more of the element T is Ti or Nb. By using Ti or Nb, even if the content of the element T is reduced, it is possible to greatly reduce the precipitation amount of the α-(Fe, Co) phase while stabilizing the ThMn₁₂ crystal phase.

In order to increase the saturation magnetization of the magnetic material, it is preferable to reduce the addition amount of the element T. However, the reduction of the addition amount of the element T may cause precipitation of a Nd₃(Fe, Ti)₂₉ crystal phase and thus decrease of the saturation magnetization. In order to suppress the precipitation of the Nd₃(Fe, Ti)₂₉ crystal phase with the decrease of the addition amount of the element T, it is effective to increase the addition amount of Y. This enables an increase of the saturation magnetization. If the addition amount c of the element T is a number satisfying 0<c<4.5 atomic percent, x is preferably a number satisfying 0.1<x<0.6. If c is a number satisfying 1.5<c<4 atomic percent, x is preferably a number satisfying 0.15<x≤0.55. If c is a number satisfying 3<c≤3.8 atomic percent, x is preferably a number satisfying 0.3<x≤0.5.

The element D is at least one element selected from the group consisting of copper (Cu), tin (Sn), indium (In), and gallium (Ga) for example. By adding the element T, it is possible to form the sub phase 2 containing the element D, and to improve the coercive force. However, since the element D is a nonmagnetic element, by the introduction of a lot of element D, resulting in that the saturation magnetization of the magnetic material easily decreases. An addition amount d of the element D is preferably a number satisfying 0.01≤d≤7 atomic percent. It is thereby possible to increase the coercive force while increasing the saturation magnetization of the magnetic material. The addition amount d is more preferably 0.015≤d≤3 atomic percent, and still more preferably 0.02≤d≤1 atomic percent

The magnetic material of this embodiment may further contain an element A. At this time, a composition of the magnetic material is expressed by a composition formula 2: (R₁₋ₓYₓ)ₐM_{b}T_{c}D_{d}Aₑ (in the formula, R is a rare-earth element of one kind or more, T is at least one element selected from the group made up of Ti, V, Nb, Ta, Mo, and W, M is Fe or Fe and Co, D is at least one element selected from the group made up of Cu and Sn, A is at least one element selected from the group consisting of N, C, B, H, and P, x is a number satisfying 0.01≤x≤0.8, a is a number satisfying 4≤a≤20 atomic percent, b is a number satisfying b=100−a−c−d−e atomic percent, c is a number satisfying 0<c<7 atomic percent, d is a number satisfying 0.01≤d≤7 atomic percent, and e is a number satisfying 0<e≤18 atomic percent).

The element A is at least one element selected from the group made up of nitrogen (N), carbon (C), boron (B), hydrogen (H), and phosphorus (P). The element A has a function of entering a crystal lattice of the ThMn₁₂ crystal phase to cause at least one of enlargement of the crystal lattice and change in electronic structure, for example. Consequently, it is possible to change the Curie temperature, the magnetic anisotropy, and the saturation magnetization. The element A does not always have to be added, except for inevitable impurities.

When 50 atomic percent or more of the element R is Sm (when a main component of the element R is Sm), the magnetic anisotropy of the ThMn₁₂ crystal phase changes from a c axis direction to a direction oriented in a plane perpendicular to the c axis due to the entrance of the element A, which decreases the coercive force. For this reason, it is preferable that the element A is not added except for inevitable impurities. On the contrary, when 50 atomic percent or more of the element R is at least one element selected from the group made up of Ce, Pr, Nd, Tb, and Dy (when the main component of the element R is at least one element selected from the group made up of Ce, Pr, Nd, Tb, and Dy), the magnetic anisotropy of the ThMn₁₂ crystal phase changes from the direction oriented in the plane perpendicular to the c axis to the c axis direction due to the entrance of the element A, which enables to increase the coercive force. For this reason, the element A is preferably added. When the element A is added, the concentration e of the element A is preferably a number satisfying 0<e≤18 atomic percent. When the concentration e exceeds 18 atomic percent, the stability of the ThMn₁₂ crystal phase decreases. The concentration e of the element A is more preferably a number satisfying 0<e≤14 atomic percent.

The magnetic material including the ThMn₁₂ crystal phase as the main phase 1 exerts the coercive force according to a new creation type coercive force mechanism where the magnetization-reversal nucleus is generated at a part of crystal grains, and an inverse domain area is propagated to other crystal grains to be demagnetized. At least one of suppression of the generation of the magnetization-reversal nucleus and suppression of the propagation of the inverse domain region of the main phase 1 is effective to increase the coercive force. The magnetic material of this embodiment includes the sub phase 2 containing the element D, and it is possible to improve the coercive force owing to the sub phase 2 taking charge of the above-stated function.

Though the sub phase 2 is formed by heat treatment, when sintering is performed to form the permanent magnet, a melting point of the sub phase 2 is preferably lower than a sintering temperature. Further, the melting point of the sub phase 2 is preferably lower than a forming temperature of the ThMn₁₂ crystal phase to stabilize the ThMn₁₂ crystal phase of the main phase 1. When the melting point of the sub phase 2 is too low, alteration of the sub phase 2 under a high-temperature environment from among use environments of magnet and deterioration of properties due to a partial melting may occur. The melting point of the sub phase 2 is therefore necessary to be sufficiently higher than the use environment temperature. The melting point of the sub phase 2 is preferably 250° C. or more and 1200° C. or less, and more preferably 300° C. or more and 1100° C. or less.

In order to effectively suppress the inverse domain propagation between the main phases 1 by the sub phase 2, the sub phase 2 is preferably non-ferromagnetism, and more preferably non-magnetism. The magnetic material of this embodiment contains the element D in the sub phase 2. Since the element D is a non-magnetic element, it is possible to weaken the magnetism of the sub phase 2 by making the sub phase 2 contain a lot of element D. A concentration of the element D in the sub phase 2 is preferably 10 atomic percent or more. A preferable content of the element D in the sub phase 2 differs depending on the kind of the element D, where it is preferably 40 atomic percent or more in case of Cu, and it is preferably 25 atomic percent or more in case of Sn. At this time, the sub phase 2 includes at least one of a phase containing 40 atomic percent or more of Cu or a phase containing 25 atomic percent or more of Sn. More preferably, 45 atomic percent or more of Cu or 30 atomic percent or more of Sn.

As the phase containing 40 atomic percent or more of Cu, there can be cited, for example, a SmCu phase, a SmCu₂ phase, a Sm₂Cu₇ phase, a Sm₂Cu₉ phase, a SmCu₅ phase, a SmCu₆ phase, or the like. As the phase containing 25 atomic percent or more of Sn, there can be cited, for example, a Sm₅Sn₃ phase, a Sm₄Sn₃ phase, a Sm₅Sn₄ phase, a Sm₂Sn₃ phase, a SmSn₂ phase, a SmSn₃ phase, or the like.

As illustrated in FIG. 1, it is preferable that the sub phase 2 continuously surrounds the main phase 1. By surrounding the main phase 1, the reverse domain propagation is effectively suppressed to further increase the coercive force.

It is also preferable that fine particle phases of the sub phase 2 are dispersed in the metallic structure. FIG. 2 is a cross-sectional schematic diagram illustrating another structural example of a metal structure. Miniaturization of the sub phase 2 increases a contact area with the main phase 1 to effectively prevent formation of the inverse domain. The presence of the fine particle phases enables miniaturization of the main phase 1 and thus the coercive force of each crystal grain. An average grain diameter of the main phase 1 is preferably 10 μm or less. The metallic structure may includes a first sub phase and a second sub phase, the first sub phase being dispersed therein, and the second sub phase surrounding the main phase 1.

An average particle diameter of the sub phase 2 is preferably 0.0005 μm or more and 2 μm or less. The average particle diameter less than 0.0005 μm prevents division a magnetic connection between two or more the main phases 1 across the sub phase 2 and facilitates inverse domain propagation. The average particle diameter more than 2 μm increases a contact volume of two or more of the crystal grains and facilitates formation of the inverse domain and inverse domain propagation. The average particle diameter is more preferably 0.001 μm or more and 1.5 μm or less. More preferably, the average particle diameter is 0.0015 μm or more and 1 μm or less. Furthermore preferably, the average particle diameter is 0.002 μm or more and 0.5 μm or less.

The fine particle phases are preferably dispersed in all of the magnetic material. Unbalance dispersion of the particle phases increase a ratio of the main phase 1 being out of contact with sub phase 2 and facilitate formation of the inverse domain and the inverse domain propagation. If a cross section of the magnetic material is divided into a plurality of partitions and each size of the partitions is 5 μm×5 μm, an area ratio of the partition having the sub phase 2 is 50% or more to the cross section. The area ratio of the partition having the sub phase 2 is preferably 70% or more to the cross section. The area ratio of the partition having the sub phase 2 is more preferably 90% or more to the cross section. The area ratio of the partition having the sub phase 2 is furthermore preferably 95% or more to the cross section.

The composition of the magnetic material is measured through, for example, inductively coupled plasma-atomic emission spectroscopy (ICP-AES), scanning electron microscope-energy dispersive X-ray spectroscopy (SEM-EDX), transmission electron microscope-energy dispersive X-ray spectroscopy (TEM-EDX), scanning transmission electron microscope-energy dispersive X-ray spectroscopy (STEM-EDX), or the like. The volume ratios of the respective phases are determined in a comprehensive manner by using both of observation with an electron microscope or an optical microscope, and the X-ray diffraction or the like.

The concentrations of the respective elements of the main phase 1 and the sub phase 2 are measured by using the SEM-EDX or STEM-EDX, for example. For example, the main phase 1 and the sub phase 2 can be specified by an observation image obtained through the SEM and a mapping image of each element of a measurement sample of the magnetic material obtained through the SEM-EDX or STEM-EDX.

If the particle phases of the sub phase 2 are formed, an average particle diameter of the sub phases 2 can be determined as follows. In the sub phases 2 shown in a mapping image of the SEM-EDX or STEM-EDX, an arbitrary particle phase is selected, and a longest straight line A having both ends in contact with another phase is drawn for the selected particle phase. Then, at a center point of the straight line A, a straight line B orthogonal to the straight line A and having both ends in contact with another phase is drawn. The average of the lengths of the straight line A and the straight line B is regarded as a diameter D of the particle phase. By the above procedure, Ds of one or more of arbitrary phases are found. The D is calculated in five visual fields for one sample and the average of the Ds is defined as the diameter (D). The above method can be used for determination of the average grain diameter of the main phase 1.

Next, an example of a manufacturing method of the magnetic material of this embodiment will be described. First, an alloy containing predetermined elements required for the magnetic material is manufactured. The alloy can be manufactured by using, for example, an arc melting method, a high-frequency melting method, a metal mold casting method, a mechanical alloying method, a mechanical grinding method, a gas atomizing method, a reduction diffusion method, or the like. Note that the concentration of the element D in the sub phase 2 can be adjusted in accordance with the addition amount of a raw material of the element D.

Further, the above-described alloy can be melted to be subjected to rapid cooling. This enables to stably obtain the ThMn₁₂ crystal phase and to reduce the precipitation amount of the α-(Fe, Co) phase. The melted alloy is rapidly cooled by using a liquid quenching method, for example. In the liquid quenching method, the alloy molten metal is applied on a rapidly rotating roll. The roll may be one of either a single-roll type or a twin-roll type, and may include metal such as copper. By controlling a amount of the applied metal and a rotation speed of the roll, a cooling rate of the molten metal can be controlled.

The strip cast method of methods of manufacturing alloy has a cooling rate slower than another liquid quenching method. An increase of the cooling rate effectively facilitates miniaturization of the metallic structure and homogenization of the metallic structure.

Heat treatment may also be performed on the above-described alloy thin strip. This enables to homogenize the material. For example, heating is performed at a temperature of 700° C. or more and 1300° C. or less for 5 minutes or more and 200 hours or less. Consequently, it becomes possible to increase the stability of the ThMn₁₂ crystal phase, to easily form the sub phase 2, and to further improve both properties of the saturation magnetization and the coercive force. The heat treatment at the temperature less than 900° C. facilitates fine dispersion of the sub phases 2. The heat treatment at the temperature more than 1000° C. facilitates formation of the sub phases 2 between the main phases 1.

It is also possible to make the element A enter the above-described alloy thin strip. It is preferable that the alloy is pulverized into a powder before the process of making the element A enter the alloy. When the element A is nitrogen, by heating the alloy thin strip for 1 hour or more and 100 hours or less in an atmosphere of nitrogen gas, ammonia gas, or the like at about 0.1 atmospheric pressure or more and 100 atmospheric pressure or less, in a temperature of 200° C. or more and 700° C. or less, it is possible to nitride the alloy thin strip to make the element N enter the alloy thin strip. When the element A is carbon, by heating the alloy thin strip for 1 hour or more and 100 hours or less in an atmosphere of C₂H₂, CH₄, C₃H₈, or CO gas or thermal decomposition gas of methanol at about 0.1 atmospheric pressure or more and 100 atmospheric pressure or less in a temperature range of 300° C. or more and 900° C. or less, it is possible to carbonize the alloy thin strip to make the element C enter the alloy thin strip. When the element A is hydrogen, by heating the alloy thin strip for 1 to 100 hours in an atmosphere of hydrogen gas, ammonia gas, or the like at about 0.1 to 100 atmospheric pressure, in a temperature range of 200 to 700° C., it is possible to hydrogenate the alloy thin strip to make the element H enter the alloy thin strip. When the element A is boron, by making a raw material contain boron when manufacturing the alloy, it is possible to make boron to be contained in the alloy thin strip. When the element A is phosphorus, by phosphorizing the alloy thin strip, it is possible to make the element P enter the alloy thin strip.

The magnetic material is manufactured through the above-described process. Further, the permanent magnet is manufactured by using the aforementioned magnetic material. An example of a magnet manufacturing process is presented. A compact is obtained by pulverizing the aforementioned magnetic material using milling machines such as a jet mill and a ball mill and then performing magnetic field orientation pressing in a magnetic field of about 1 to 2 T at a pressure of about 1 ton. A sintered body is manufactured by heating and sintering the obtained compact in an atmosphere of inert gas such as Ar and in vacuum. The sintered body is properly heat treated in the inert atmosphere or the like, and thereby, a permanent magnet can be manufactured. Further, by pulverizing the aforementioned magnetic material and then performing solidification using a resin or the like, a bond magnet including the aforementioned magnetic material is manufactured.

### Second Embodiment

The permanent magnet including the magnetic material of the first embodiment can be used for various motors and generators. Further, it is possible to use the permanent magnet as a stationary magnet or a variable magnet of a variable magnetic flux motor or a variable magnetic flux generator. Various motors and generators are formed by using the permanent magnet of the first embodiment. When the permanent magnet of the first embodiment is applied to a variable magnetic flux motor, techniques disclosed in, for example, Japanese Patent Application Laid-open No. 2008-29148 or Japanese Patent Application Laid-open No. 2008-43172 can be applied to a configuration and a drive system of the variable magnetic flux motor.

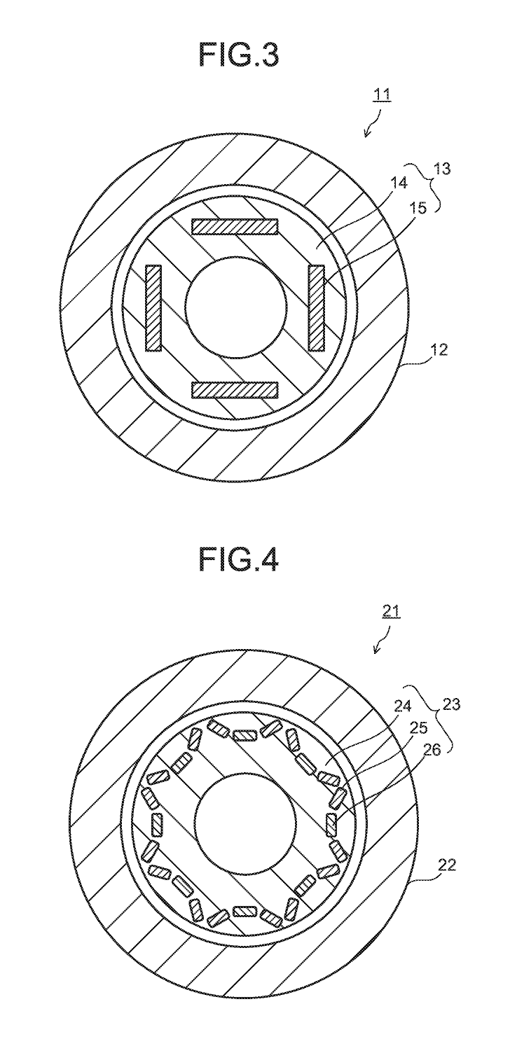

Next, a motor and a generator including the above-described permanent magnet will be described with reference to the drawings. FIG. 3 is a diagram illustrating a permanent magnet motor. In a permanent magnet motor 11 illustrated in FIG. 3, a rotor 13 is disposed in a stator 12. In an iron core 14 of the rotor 13, permanent magnets 15 being the permanent magnets of the first embodiment are disposed. By using the permanent magnets of the first embodiment, high efficiency, reduction in size, cost reduction and the like of the permanent magnet motor 11 can be achieved based on properties and the like of the respective permanent magnets.

FIG. 4 is a diagram illustrating a variable magnetic flux motor. In a variable magnetic flux motor 21 illustrated in FIG. 4, a rotor 23 is disposed in a stator 22. In an iron core 24 of the rotor 23, the permanent magnet of the first embodiment is disposed as stationary magnets 25 and variable magnets 26. A magnetic flux density (magnetic flux amount) of the variable magnet 26 is variable. A magnetization direction of the variable magnet 26 is orthogonal to a Q-axis direction, and thus the magnets are not affected by a Q-axis current, and can be magnetized by a D-axis current. A magnetization winding (not illustrated) is provided on the rotor 23. It is structured such that by passing a current through the magnetization winding from a magnetizing circuit, a magnetic field thereof operates directly on the variable magnet 26.

According to the permanent magnet of the first embodiment, it is possible to obtain the coercive force suitable for the stationary magnets 25. When the permanent magnets of the first embodiment are applied to the variable magnets 26, it is only required to control the coercive force, for example, to fall within a range of 100 kA/m or more and 500 kA/m or less by changing the manufacturing conditions. In the variable magnetic flux motor 21 illustrated in FIG. 4, the permanent magnets of the first embodiment can be used for both of the stationary magnets 25 and the variable magnets 26, but, it is also possible to use the permanent magnets of the first embodiment for either of the magnets. The variable magnetic flux motor 21 is capable of outputting a large torque from a small device size, and thus is preferred for a motor of a hybrid electric vehicle, electric vehicle, or the like required to have high output power and small size of the motor.

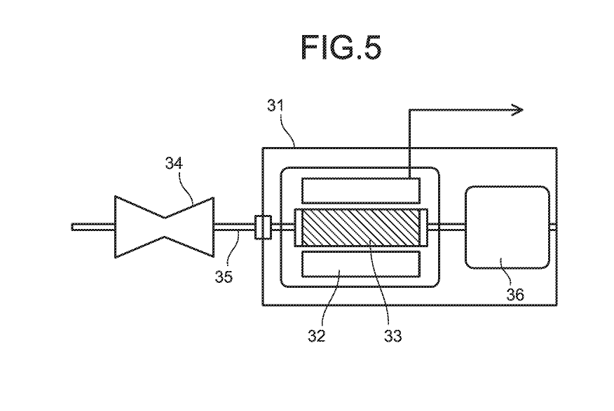

FIG. 5 illustrates a generator. A generator 31 illustrated in FIG. 5 includes a stator 32 using the above-described permanent magnet. A rotor 33 disposed inside the stator 32 is connected via a shaft 35 to a turbine 34 provided at one end of the generator 31. The turbine 34 is rotated by an externally supplied fluid, for example. Instead of the turbine 34 rotated by the fluid, the shaft 35 can also be rotated by transmitting dynamic rotation such as regenerative energy of an automobile. To the stator 32 and the rotor 33, various publicly-known configurations can be used.

The shaft 35 is in contact with a commutator (not illustrated) disposed on an opposite side of the turbine 34 with respect to the rotor 33, and electromotive force generated by rotations of the rotor 33 is increased in voltage to a system voltage and transmitted as output of the generator 31 via isolated phase buses and a main transformer (not illustrated). The generator 31 may be either of an ordinary generator and a variable magnetic flux generator. A static electricity from the turbine 34 or charges by an axial current accompanying power generation occur on the rotor 33. For this reason, the generator 31 includes a brush 36 for discharging the charges of the rotor 33.

An use of the above-described permanent magnet to the generator enable effects such as high efficiency, reduction in size, and cost reduction.

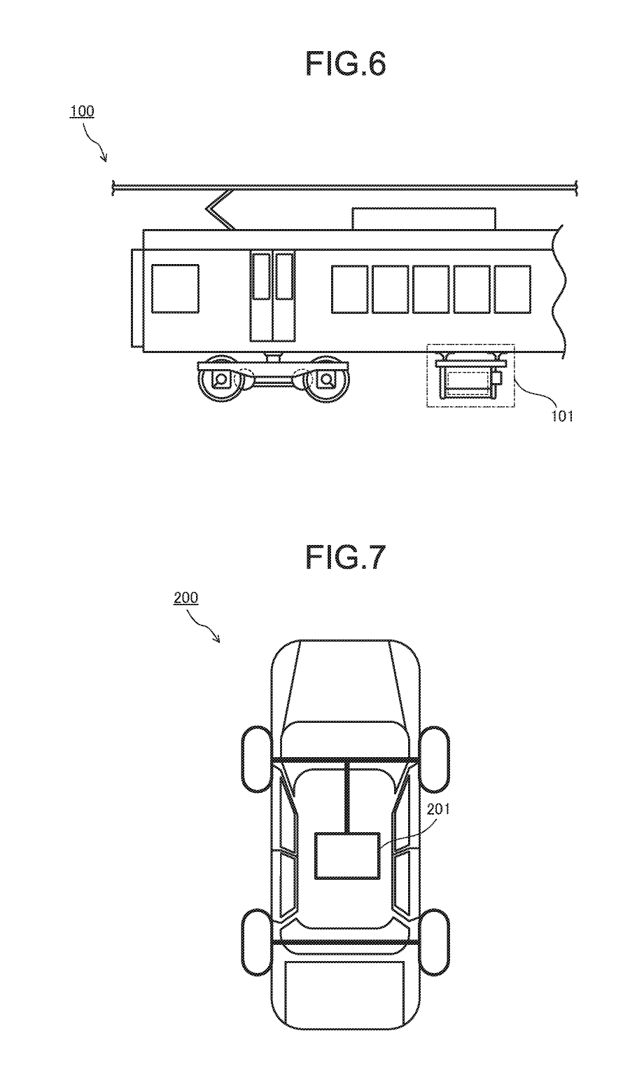

The above-described rotary electrical machine may be mounted on a railroad vehicle (one example of vehicle) used in railway traffic, for example. FIG. 6 is a diagram illustrating one example of a railroad vehicle 100 including a rotary electrical machine 101. As the rotary electrical machine 101, the motor in FIG. 3 or FIG. 4, the generator in FIG. 5 described above, or the like can be used. When the above-described rotary electrical machine is mounted as the rotary electrical machine 101, the rotary electrical machine 101 may be used as an electric motor (motor) which outputs a driving force by utilizing electric power supplied from a power transmission line or electric power supplied from a secondary battery mounted on the railroad vehicle 100, for example, or it may also be used as a generator which converts kinetic energy into electric power and supplies the electric power to various loads in the railroad vehicle 100. By utilizing a highly efficient rotary electric machine such as the rotary electrical machine of the embodiment, it is possible to make the railroad vehicle travel while saving energy.

The aforementioned rotary electrical machine may also be mounted on an automobile (another example of vehicle) such as a hybrid electric vehicle or an electric vehicle. FIG. 7 is a diagram illustrating one example of an automobile 200 including a rotary electrical machine 201. As the rotary electrical machine 201, the motor in FIG. 3 or FIG. 4, the generator in FIG. 5 described above, or the like can be used. When the above-described rotary electrical machine is mounted as the rotary electrical machine 201, the rotary electrical machine 201 may be used as an electric motor which outputs a driving force of the automobile 200, or it may also be used as a generator which converts kinetic energy at the time of traveling the automobile 200 into electric power. The rotary electrical machine may be mounted on, for example, industrial equipment (industrial motor), air-conditioning equipment (air conditioner, hot water supply compressor motor), a wind power generator, or an elevator (hoisting machine).

### EXAMPLES

### Examples 1 to 8

Appropriate amounts of raw materials were weighed to produce alloys by using the arc melting method. Next, each of the alloys was melted, and the obtained molten metal was subjected to rapid cooling by using the strip cast method, to thereby produce an alloy thin strip. The above-described alloy thin strips were heated for 5 hours at 1000° C. under an Ar atmosphere. Thereafter, compositions of the alloy thin strips after being subjected to the heating were analyzed by using the ICP-AES. The compositions of the magnetic materials determined by using the ICP-AES are presented in Table 1.

Next, each of the alloy thin strips was pulverized by a jet mill to produce an alloy powder, and a permanent magnet was obtained by molding in a magnetic field and performing heat treatment. As a result of the SEM-EDX analysis for the obtained permanent magnet, it was confirmed that the permanent magnet includes a metal structure having the ThMn₁₂ crystal phase as its main phase, and a sub phase containing the element D. The element D concentration in the sub phase was calculated from the SEM-EDX analysis. Further, the coercive force of the permanent magnet was evaluated by using a vibrating sample magnetometer (VSM). In addition, the shape of the sub phase was evaluated. Results are illustrated in Table 1.

### Examples 9 to 10

Appropriate amounts of raw materials were weighed to produce alloys by using the arc melting method. Next, each of the alloys was melted, and the obtained molten metal was subjected to rapid cooling by using the strip cast method, to thereby produce an alloy thin strip. The above-described alloy thin strips were heated for 4 hours at 1100° C. under an Ar atmosphere. Thereafter, each of the alloy thin strips was pulverized in a mortar, and the obtained powder was heated for 4 hours at 450° C. in a nitrogen gas atmosphere. After that, compositions of the alloy powders were analyzed by using the ICP-AES. The compositions of the magnetic materials determined by using the ICP-AES are presented in Table 1.

Next, each of the alloy thin strips was pulverized by a jet mill to produce an alloy powder, and a permanent magnet was obtained by a spark plasma sintering (SPS) method after molding in a magnetic field. As a result of the SEM-EDX analysis for the obtained permanent magnet, it was confirmed that the permanent magnet includes a metal structure having the ThMn₁₂ crystal phase as its main phase, and a sub phase containing the element D. The element D concentration in the sub phase was calculated from the SEM-EDX analysis. Further, the coercive force of the permanent magnet was evaluated by using the VSM. In addition, the shape of the sub phase was evaluated. Results are illustrated in Table 1.

### Examples 11 to 14

Appropriate amounts of raw materials were weighed to produce alloys by using the arc melting method. Next, each of the alloys was melted, and the obtained molten metal was rapidly cooled at a cooling rate faster than a cooling rate of the strip cast method by applying the molten metal on a single-roll rotating at a rotating rate of 15 m/s, to thereby produce an alloy thin strip. The above-described alloy thin strips were heated for 15 minutes at 850° C. under an Ar atmosphere. After that, compositions of the alloy powders were analyzed by using the ICP-AES. The compositions of the magnetic materials determined by using the ICP-AES are presented in Table 1.

Next, each of the alloy thin strips was pulverized by a jet mill to produce an alloy powder, and a permanent magnet was obtained by SPS method after molding in a magnetic field. As a result of the SEM-EDX analysis for the obtained permanent magnet, it was confirmed that the permanent magnet includes a metal structure having the ThMn₁₂ crystal phase as its main phase, and a sub phase containing the element D. The element D concentration in the sub phase was calculated from the SEM-EDX analysis. Further, the coercive force of the permanent magnet was evaluated by using the VSM. In addition, the average particle diameter of the sub phase and the shape of the sub phase was evaluated. Results are illustrated in Table 1.

### Examples 15 and 16

Appropriate amounts of raw materials were weighed to produce alloys by using the arc melting method. Next, each of the alloys was melted, and the obtained molten metal was rapidly cooled at a cooling rate faster than a cooling rate of the strip cast method by applying the molten metal on a single-roll rotating at a rotating rate of 15 m/s, to thereby produce an alloy thin strip. After that, compositions of the alloy powders were analyzed by using the ICP-AES. The compositions of the magnetic materials determined by using the ICP-AES are presented in Table 1.

Next, each of the alloy thin strips was pulverized by a jet mill to produce an alloy powder, and a permanent magnet was obtained by SPS method after molding in a magnetic field. As a result of the SEM-EDX analysis for the obtained permanent magnet, it was confirmed that the permanent magnet includes a metal structure having the ThMn₁₂ crystal phase as its main phase, and a sub phase containing the element D. The element D concentration in the sub phase was calculated from the SEM-EDX analysis. Further, the coercive force of the permanent magnet was evaluated by using the VSM. In addition, the average particle diameter of the sub phase and the shape of the sub phase was evaluated. Results are illustrated in Table 1.

### Comparative Example 1

A permanent magnet was obtained through the similar processes as Examples 1 to 8. As a result of the SEM-EDX analysis for the obtained permanent magnet, it was confirmed that the permanent magnet includes a metal structure having the ThMn₁₂ crystal phase as its main phase, and a sub phase. The element D concentration in the sub phase was calculated from the SEM-EDX analysis. Results are presented in Table 1. Further, the coercive force of the permanent magnet was evaluated by using the VSM. Results are illustrated in Table 1.

### Comparative Example 2

A permanent magnet was obtained through the similar processes as Examples 11 to 13. As a result of the SEM-EDX analysis for the obtained permanent magnet, it was confirmed that the permanent magnet includes a metal structure having the ThMn₁₂ crystal phase as its main phase, and a sub phase. The element D concentration in the sub phase was calculated from the SEM-EDX analysis. Results are presented in Table 1. Further, the coercive force of the permanent magnet was evaluated by using the VSM. Results are illustrated in Table 1

TABLE 1

| | | Element D | Coercive | | | Area |
|---|---|---|---|---|---|---|
| | | Concentration | Force | | Average | Ratio of |
| | | in Sub | of | | Particle | Partitions |
| | | Phase | Permanent | Shape of Sub | Diameter of | with |
| | Composition of Magnetic Material | (atomic %) | Magnet | Phase | Sub Phase | Sub Phase |
| Example 1 | (Sm_{0.8}Y_{0.2})_{8.0}(Fe_{0.8}Co_{0.2})_{87.5}Ti_{3.9}Cu_{0.6} | 51 | ◯ | Grain | — | — |
| | | | | Boundary | | |
| | | | | Phase | | |
| Example 2 | (Sm_{0.7}Y_{0.3})_{8.3}(Fe_{0.7}Co_{0.3})_{86.6}Nb_{3.8}Cu_{1.3} | 48 | Δ | Grain | — | — |
| | | | | Boundary | | |
| | | | | Phase | | |
| Example 3 | (Sm_{0.8}Y_{0.2})_{8.8}(Fe_{0.8}Co_{0.2})_{86.6}Ti_{3.8}Sn_{0.8} | 30 | Δ | Grain | — | — |
| | | | | Boundary | | |
| | | | | Phase | | |
| Example 4 | (Sm_{0.7}Y_{0.3})_{7.8}(Fe_{0.7}Co_{0.3})_{88.0}V_{3.6}Cu_{0.6} | 42 | ◯ | Grain | — | — |
| | | | | Boundary | | |
| | | | | Phase | | |
| Example 5 | (Sm_{0.7}Y_{0.2}Zr_{0.1})_{7.9}(Fe_{0.8}Co_{0.2})_{87.6}Ti_{4.0}Cu_{0.5} | 41 | Δ | Grain | — | — |
| | | | | Boundary | | |
| | | | | Phase | | |
| Example 6 | (Sm_{0.7}Y_{0.2}Zr_{0.06}Hf_{0.04})_{8.0}(Fe_{0.7}Co_{0.3})_{88.0}Nb_{3.6}Sn_{0.4} | 42 | Δ | Grain | — | — |
| | | | | Boundary | | |
| | | | | Phase | | |
| Example 7 | (Sm_{0.7}Y_{0.3})_{7.8}(Fe_{0.7}Co_{0.29}Al_{0.01})_{88.0}Ti_{3.6}Cu_{0.6} | 46 | ◯ | Grain | — | — |
| | | | | Boundary | | |
| | | | | Phase | | |
| Example 8 | (Sm_{0.7}Y_{0.3})_{7.8}(Fe_{0.70}Co_{0.29}Ga_{0.01})_{88.1}Ti_{3.6}Cu_{0.5} | 47 | ◯ | Grain | — | — |
| | | | | Boundary | | |
| | | | | Phase | | |
| Example 9 | (Nd_{0.7}Y_{0.3})_{7.5}(Fe_{0.7}Co_{0.3})_{82.4}Nb_{3.3}N_{6.4}Sn_{0.4} | 28 | Δ | Grain | — | — |
| | | | | Boundary | | |
| | | | | Phase | | |
| Example 10 | (Sm_{0.6}Nd_{0.1}Y_{0.3})_{7.4}(Fe_{0.8}Co_{0.2})_{82.5}Nb_{3.3}N_{6.3}Cu_{0.5} | 41 | Δ | Grain | — | — |
| | | | | Boundary | | |
| | | | | Phase | | |
| Example 11 | (Sm_{0.8}Y_{0.2})_{8.0}(Fe_{0.8}Co_{0.2})_{87.4}Ti_{4.0}Cu_{0.6} | 53 | ◯ | Particle Phase | 0.6 μm | 95% |
| Example 12 | (Sm_{0.7}Y_{0.3})_{8.3}(Fe_{0.7}Co_{0.3})_{86.7}Nb_{3.7}Cu_{1.3} | 51 | ◯ | Particle Phase | 0.9 μm | 93% |
| Example 13 | (Sm_{0.8}Y_{0.2})_{8.6}(Fe_{0.8}Co_{0.2})_{86.8}Ti_{4.0}Sn_{0.6} | 32 | ◯ | Particle Phase | 1.5 μm | 91% |
| Example 14 | (Sm_{0.8}Y_{0.2})_{8.0}(Fe_{0.8}Co_{0.2})_{87.4}Ti_{4.0}Cu_{0.6} | 49 | ◯ | Particle Phase | 0.3 μm | 97% |
| Example 15 | (Sm_{0.7}Y_{0.3})_{8.3}(Fe_{0.7}Co_{0.3})_{86.7}Nb_{3.7}Cu_{1.3} | 52 | ◯ | Particle Phase | 0.08 μm | 95% |
| Example 16 | (Sm_{0.8}Y_{0.2})_{8.6}(Fe_{0.8}Co_{0.2})_{86.8}Ti_{4.0}Sn_{0.6} | 31 | ◯ | Particle Phase | 0.1 μm | 98% |
| Comparative | (Sm_{0.8}Y_{0.2})_{7.5}(Fe_{0.8}Co_{0.2})_{88.5}Ti_{4.0} | 0 | X | — | — | — |
| Example 1 | | | | | | |
| Comparative | (Sm_{0.8}Y_{0.2})_{7.5}(Fe_{0.8}Co_{0.2})_{88.5}Ti_{4.0} | 0 | X | — | — | — |
| Example 2 | | | | | | |

In each of Examples 1 to 16 and Comparative examples 1 and 2, it was determined to be “Good” when the coercive force increased 50% or more and 200% or less, and it was determined to be “Very Good” when the coercive force increased over 200% with respect to the coercive force of Comparative example 1 when the coercive force of Comparative example 1 was set as “Bad”. As it is clear from Table 1, the sub phase containing the element D was formed, and improvement in the coercive force was confirmed in each of the permanent magnets of Examples 1 to 16. On the other hand, there was no sub phase containing the element D, and the coercive force was seldom exerted in the magnetic material of Comparative examples 1 and 2.

It is to be noted that, although some embodiments of the present invention have been described, these embodiments have been presented by way of example and are not intended to limit the scope of the invention. These novel embodiments can be implemented in a variety of other modes, and various omissions, substitutions, and modifications thereof can be made within the scope that does not depart from the spirit of the invention. Such embodiments and modifications thereof are encompassed by the scope and the spirit of the invention and also encompassed by the invention set forth in the claims and equivalents thereof.

What is claimed is:

1. A magnetic material expressed by
a composition formula 1: (R₁₋ₓYₓ)ₐM_{b}T_{c}D_{d}
where R is at least one element selected from the group consisting of rare-earth elements, M is Fe or Fe and Co, T is at least one element selected from the group consisting of Ti, V, Nb, Ta, Mo, and W, D is at least one element selected from the group consisting of Cu, and Sn, x is a number satisfying 0.01≤x≤0.8, a is a number satisfying 4≤a≤20 atomic percent, b is a number satisfying b=100−a−c−d atomic percent, and c is a number satisfying 0<c<7 atomic percent, and d is a number satisfying 0.01≤d≤7 atomic percent,
the magnetic material comprising:
a main phase having a ThMn₁₂ crystal phase, and
a sub phase having at least one phase selected from the group consisting of a first phase containing 40 atomic percent or more of Cu and a second phase containing 25 atomic percent or more of Sn.

2. The magnetic material according to claim 1,
wherein 50 atomic percent or more of the element R is Sm.

3. The magnetic material according to claim 1,
wherein 50 atomic percent or less of the element Y is replaced with at least one element selected from the group consisting of Zr and Hf.

4. The magnetic material according to claim 1,
wherein 50 atomic percent or more of the element T is Ti or Nb.

5. The magnetic material according to claim 1,
wherein 20 atomic percent or less of the element M is replaced with at least one element selected from the group consisting of Al, Si, Cr, Mn, Ni, and Ga.

6. A magnetic material is expressed by
a composition formula 2: (R₁₋ₓYₓ)ₐM_{b}T_{c}D_{d}Aₑ
where R is at least one element selected from the group consisting of rare-earth elements, M is Fe or Fe and Co, T is at least one element selected from the group consisting of Ti, V, Nb, Ta, Mo, and W, D is at least one element selected from the group consisting of Cu and Sn, A is at least one element selected from the group consisting of N, C, B, H, and P, x is a number satisfying 0.01≤x≤0.8, a is a number satisfying 4≤a≤20 atomic percent, b is a number satisfying b=100−a−c−d−e atomic percent, c is a number satisfying 0<c<7 atomic percent, d is a number satisfying 0.01≤d≤7 atomic percent, and e is a number satisfying 0<e≤18 atomic percent,
the magnetic material comprising:
a main phase having a ThMn₁₂ crystal phase, and
a sub phase having at least one phase selected from the group consisting of a first phase containing 40 atomic percent or more of Cu and a second phase containing 25 atomic percent or more of Sn.

7. The magnetic material according to claim 6,
wherein 50 atomic percent or more of the element R is at least one element selected from the group consisting of Ce, Pr, Nd, Tb, and Dy.

8. The magnetic material according to claim 6,
wherein 50 atomic percent or less of the element Y is replaced with at least one element selected from the group consisting of Zr and Hf.

9. The magnetic material according to claim 6,
wherein 50 atomic percent or more of the element T is Ti or Nb.

10. The magnetic material according to claim 6,
wherein 20 atomic percent or less of the element M is replaced with at least one element selected from the group consisting of Al, Si, Cr, Mn, Ni, and Ga.

11. The magnetic material according to claim 1,
wherein the first phase is a SmCu phase, a SmCu₂ phase, a Sm₂Cu₇ phase, a Sm₂Cu₉ phase, a SmCu₅ phase, or a SmCu₆ phase, and
the second phase is a Sm₅Sn₃ phase, a Sm₄Sn₃ phase, a Sm₅Sn₄ phase, a Sm₂Sn₃ phase, a SmSn₂ phase, or a SmSn₃ phase.

12. The magnetic material according to claim 1,
wherein the first phase or the second phase continuously surrounds the main phase.

13. The magnetic material according to claim 1,
wherein a melting point of the first phase or the second phase is 250° C. or more and 1200° C. or less.

14. The magnetic material according to claim 1,
wherein an average particle diameter of the first phase or the second phase is 0.0005 μm or more and 2 μm or less.

15. The magnetic material according to claim 1,
wherein if a cross section of the magnetic material is divided into a plurality of partitions and each size of the partitions is 5 μm×5 μm, an area ratio of the partition having the at least one phase is 50% or more to the cross section.

16. The magnetic material according to claim 1,
wherein the average grain diameter of the main phase is 10 μm or less.

17. A magnetic material expressed by a composition formula 1:
(R₁₋ₓYₓ)ₐM_{b}T_{c}D_{d}
where R is at least one element selected from the group consisting of rare-earth elements, M is Fe or Fe and Co, T is at least one element selected from the group consisting of Ti, V, Nb, Ta, Mo, and W, D is at least one element selected from the group consisting of Cu, Sn, In, and Ga x is a number satisfying 0.01≤x≤0.8, a is a number satisfying 4≤a≤20 atomic percent, b is a number satisfying b=100−a−c−d atomic percent, and c is a number satisfying 0<c<7 atomic percent, and d is a number satisfying 0.01≤d≤7 atomic percent,
the magnetic material comprising:
a main phase having a ThMn₁₂ crystal phase, and
a sub phase containing the element D,
wherein a melting point of the sub phase is 250° C. or more and 1200° C. or less.

18. A permanent magnet, comprising the magnetic material according to claim 1.

19. A permanent magnet, comprising a sintered body of the magnetic material according to claim 1.

20. A rotary electrical machine, comprising:
a stator; and
a rotor,
wherein the stator or the rotor has the magnet according to claim 19.

21. The machine according to claim 20,
wherein the rotor is connected to a turbine via a shaft.

22. A vehicle comprising the machine according to claim 20.

23. The vehicle according to claim 22,
wherein the rotor is connected to a shaft, and
rotation is transmitted to the shaft.
